(19) United States
(12) Patent Application Publication
(10) Pub. No.: US 2015/0236808 A1
(43) Pub. Date: Aug. 20, 2015

(54) METHOD AND APPARATUS FOR RADIO LINK ADAPTATION FOR FLEXIBLE SUBFRAME COMMUNICATIONS

(71) Applicant: Telefonaktiebolaget L M Ericsson (publ), Stockholm (SE)

(72) Inventors: Jinhua Liu, Beijing (CN); Yu Qian, Beijing (CN); Hai Wang, Beijing (CN)

(21) Appl. No.: 14/430,265

(22) PCT Filed: Sep. 25, 2012
(86) PCT No.: PCT/CN2012/081897

§ 371 Date: Mar. 23, 2015

(51) Int. Cl. H04J 11/00; H04W 72/04; H04W 72/08; H04L 1/00

(52) U.S. Cl. CPC H04J 11/0056; H04L 1/0004; H04L 1/001; H04W 72/042; H04W 72/082

(57) ABSTRACT

The present disclosure relates to a method in a base station and to a base station for link adaption. The base station serves a UE and is configured to indicates a modulation and coding scheme and uplink radio resources for transmission by the UE of a succeeding flexible subframe. The base station receives an uplink transmission from the UE and demodulates one or more flexible subframes including perform error detection and determining an estimate of SINR. The base station determines if that flexible uplink subframe was affected by interference caused by a DL data payload transmission from a neighboring base station during that same flexible subframe. Based on that the decision, the base station determines and applies an adaptation value to the estimated SINR. It then selects a modulation and coding scheme or other transmission parameter(s), e.g., transmission bit rate, for a succeeding uplink transmission from the UE in flexible uplink and provides it to the UE.

### TECHNICAL FIELD

The technology relates to cellular radio communications involving flexible subframes and radio link adaptation.

INTRODUCTION

The dynamic uplink/downlink (UL/DL) subframe configuration was studied in 3GPP TR 36.828. The Ministry of Industry and Information Technology (MIIT) of China identifies dynamic uplink/downlink subframe configuration (also referred to as dynamic time division duplex (TDD) below) as a key feature for improving performance in hot spot and indoor radio communication situations.

With dynamic TDD, neighboring cells can be configured with different uplink downlink subframe configurations. In this application, subframes that can be configured to different transmission directions—uplink or downlink—are referred to as flexible subframes.

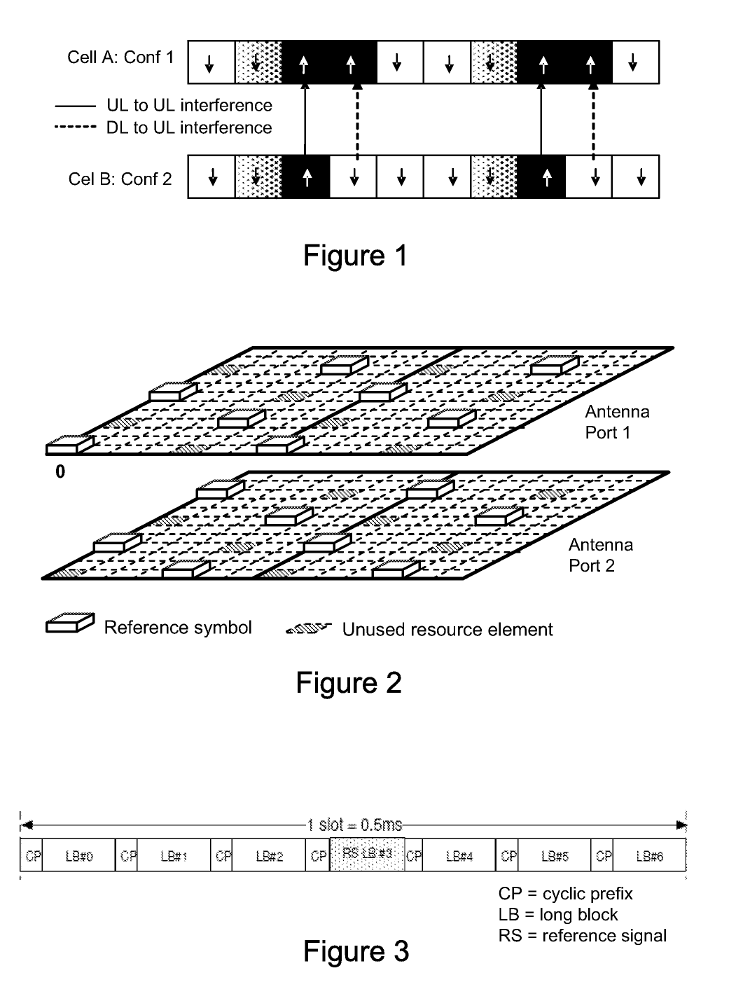

FIG. 1 shows an LTE-based example for neighboring cells A and B that are configured with different UL/DL subframe configurations 1 and 2, respectively, where each subframe configuration includes 10 subframes labeled 0-9. In cell A, subframes 2 and 7 experience interference from the uplink transmission of the UE in cell B, while subframes 3 and 8 experience interference from the downlink transmission in cell B. In the downlink, a Physical Downlink Control Channel (PDCCH) in an LTE system is specified to be transmitted in the first 1 to 3 symbols of the 1^{st} slot according to a configured Control Format Indicator (CFI). In uplink, the Physical Uplink Control Channel (PUCCH) is specified to be transmitted over the preconfigured side Physical Resource Blocks (PRBs) in both sides of the carrier bandwidth.

FIGS. 2 and 3 show an LTE-based example frame structure of Cell-specific Reference Signals (CRSs) and uplink DeModulation-Reference Signals (DM-RSs). FIG. 2 shows the CRS symbol locations in a two-frame-grid PRB structure in the example case of two antenna ports. The CRS symbols located in the PRB are shown as raised resource elements, unused resource elements are gray, and white resource elements are used to transmit multiple time-frequency multiplexed physical channels such as PDCCH, Physical ARQ Indicator Channel (PHICH), Physical Downlink Shared Channel (PDSCH), etc. FIG. 3 shows one 0.5 msec time slot where long blocks (LBs) of data are separated by cyclic prefixes (CPs), and in the center of the time slot is a reference signal long block (RSLB) used to transmit reference signals. Reference signals are known in advance by UEs and are used by the eNB to estimate radio channels and radio channel quality etc.

Returning to FIG. 1, flexible subframes 3, 8 are configured as downlink subframes in cell B but as uplink subframes in cell A. For cell B, the downlink signals in flexible subframes 3, 8 that are in the control region indicated by the CFI (e.g., PHICH and PDCCH are examples of channels in the control region) and in the reference signal region (e.g., CRS) do not interfere with the uplink DM-RS in cell A, but interfere with some of the data symbols in the uplink of cell A, because the transmission times of the downlink control signals do not overlap with the uplink transmission times of DM-RS as illustrated in FIG. 2 and FIG. 3. A Signal to Interference and Noise Ratio (SINR) for uplink signals in cell A is usually estimated based on demodulation results of signals received from UEs including measured interference and estimated channel response. It is difficult to ensure that the uplink data SINR estimation in cell A is accurate because the interference measurement is based only on the received DM-RS from the UE and not on interference on the uplink data symbols. When there is a large difference between the interference affecting the received DM-RS and the interference affecting the uplink data symbols, the interference measurement used to estimate SINR, and thus, the SINR estimate itself can not reflect the experienced radio channel quality of the data symbols. This can be a significant problem.

Subframes 2 and 7 in FIG. 1 are configured as uplink subframes in both cell A and cell B. In the uplink, the channel quality measurement and estimation accuracy can be ensured since the uplink DM-RS symbols experience similar interference as the uplink data symbols in Cell A because the Physical Uplink Shared Channel (PUSCH) signal and DM-RS signal transmitted by the UE in Cell B are allocated with the same transmit power and take over all the symbols of the allocated PRBs.

An objective of link adaptation is to adapt the data transmission bitrates according to the radio channel quality, available time-frequency resources, buffer status, and/or other parameters so that the system performance and the user experience can be optimized or at least improved. A simple example of uplink link adaptation now described. Assume in this non-limiting example that a user equipment (UE) has a full traffic buffer. Over the scheduled physical resource blocks (PRBs) for the UE, the SINR of the UE signal received by a serving base station is measured by that base station in every subframe in order to select a modulation and coding scheme (MCS) for the UE to use in transmitting succeeding subframes to that base station. SINR can be mapped to block error rate (BLER) or block error probability (BLEP). In order to maintain a predetermined BLER or BLEP target set for the UE's uplink communications to the base station, a “delta value” Δ_{adapted} is used to adjust SINR error to reduce the error between the target BLER or BLEP and the actual or achieved BLEP or BLEP. The “delta value” Δ_{adapted} is adapted based on the base station's decoding results of subframes received from the UE, e.g., using CRC bits in the subframes. The MCS is selected according to an adjusted SINR for the UL channel, which is called “effective SINR” in equation 1 below. The effective SIINR over the allocated PRBs in an analyzed, previously-received uplink subframe can be expressed as:

effectiveSINR=measSINR+Δ_{adapted} Equation 1

where measSINR is the measured SINR over the used uplink PRBs for a current subframe sent by the UE, Δ_{adapted} is the delta value, and effectiveSINR is the adapted SINR to be used in MCS selection for a future UE uplink transmission. The Δ_{adapted} is adapted to achieve a target BLER, e.g., 10%. For one example, if the estimated or measured SINR is much higher than the actual value and the Δ_{adapted} value is not low enough to compensate for the SINR estimation error, then the selected MCS may be too high to meet the predetermined BLER target. In this case, the Δ_{adapted} should be reduced to a lower value until the BLER estimate corresponding to the SINR estimate for the selected MCS meets the target BLER.

A maximum available SINR when a certain number of PRBs is allocated can be estimated using Equation 2

$$effectiveSINR = measSINR + {Δ}_{adapted} + PH + lin 2 dB ( \frac{{N}_{PRB , meas}}{{N}_{PRB , x}} ) ( in dB ) \qquad Equation 2$$

where PH is the uplink power headroom which is defined in 3GPP TS 36.211; N_{PRB,meas} is a number of used PRBs in the last uplink subframe transmitted by the UE; N_{PRB,x} is one of the possible numbers of PRBs that can be allocated to the UE in a coming uplink subframe.

The parameter Δ_{adapted} can be adapted using a “jump algorithm” as shown in Equation 3 below. Δ_{adapted} is decreased a full step size when there is CRC decoding error, and Δ_{adapted} is increased when there is a decoding success.

$${Δ}_{adapted} = \{ \begin{matrix}{Δ}_{adapted} - StepSize & ( PUSCH decoding failure ) \\ {Δ}_{adapted} + StepSize \cdot \frac{BLER}{1 - BLER} & ( PUSCH decoding success )\end{matrix} \qquad Equation 3$$

The inventors recognized that link adaptation of uplink subframes that experience interference from downlink transmissions of the neighbor cells could be further improved. In a cellular radio network, when neighboring cells are configured with different TDD uplink/downlink sub-frame configurations, if the UL subframe of the serving cell and the DL subframe of a neighboring cell overlap in the time domain, the UL transmission may be seriously interfered by the colliding DL signal. Different types of DL signals may cause different impacts. For example, when there is only reference signaling, e.g., DL CRS, or only reference and control signaling, e.g., DL CRS plus PDCCH, transmitted in a neighboring cell, the UL SINR may be over-estimated because the uplink reference signaling, e.g., DMRS, is not interfered but the uplink data payload, e.g., PUSCH, is interfered. As explained above, this UL SINR over-estimation may lead to a poor link adaptation (LA) for successive UL transmissions of that subframe.

Consider the following two cases 1 and 2 relating to a flexible subframe configured as an uplink subframe in cell A but as a downlink subframe in neighboring cell B. Case 1: when there is no DL data payload, e.g., PDSCH, transmission by cell B, but cell B transmits a DL reference signal, e.g., CRS, and/or DL control signaling, e.g., PHICH/PDCCH, the uplink channel estimation in cell A does not include the interference impact from the reference and/or control signaling transmission in cell B. As a result, the SINR can be overestimated by the base station in cell A and a too high MCS may be selected, which may result in the BLER increasing rapidly and a low delta value. Case 2: when there is a downlink data payload, e.g., PDSCH, transmission in cell B, the UL SINR estimate accuracy in cell A may be acceptable because the downlink data payload interference is typically the dominant interference, and the downlink data payload from cell B overlaps with both the UL reference signals and data over the allocated PRBs in cell A. A higher delta value may thus be expected as compared to Case 1 given the more accurate UL SINR estimation in cell A.

A problem arises with a single link adaptation loop approach that uses the underlying jump algorithm in equation (3) for transmission of the flexible subframes configured for uplink transmission with a predefined BLER target, e.g., 10%. The link adaptation can quickly decrease the delta value to a low value when there is SINR over-estimation, and the delta value only slowly increases to a desired level when the SINR over-estimation disappears. Moreover, when there are frequent changes between data payload transmission/no data payload transmission, the link adaptation usually converges to a low delta value due to the difference between the delta value increase and decrease. With the jump algorithm, the delta value increases with a small step when there is a PUSCH CRC check pass but decreases with a relatively large step (e.g., 10 times the increase step) at a PUSCH CRC check failure. As a result, the delta value is mainly determined by the transmission opportunities in Case 1, and a long time is required in order to increase the delta value to a proper level when there is a switch from Case 1 to Case 2. Moreover, performance in the Case 2 situation is seriously impacted because a too small MCS is selected for the succeeding transmissions until the delta value increases to the proper level. For the transmissions in Case 1, the delta value is still not low enough when there is switch from Case 2 to Case 1, but the delta value can be decreased to a proper level more quickly so that the impact on the performance of Case 1 is smaller.

### SUMMARY

The technology provides improved link adaptation for uplink flexible subframes (i.e., the flexible subframes configured for uplink data transmissions) that are interfered by downlink flexible subframes (i.e., the flexible subframes configured for downlink data transmissions). A base station serving a UE indicates a modulation and coding scheme and uplink radio resources for transmission by the UE of a succeeding flexible subframe. The base station receives an uplink transmission from the UE and demodulates one or more flexible subframes including perform error detection and determining an estimate of SINR. The base station determines if that flexible uplink subframe was affected by interference caused by a DL data payload transmission from a neighboring base station during that same flexible subframe. Based on that the decision, the base station determines and applies a first adaptation value or a second, different adaptation value to the estimated SINR. The base station then selects a modulation and coding scheme or other transmission parameter(s), e.g., transmission bit rate, for a succeeding uplink transmission from the UE in the flexible uplink and provides it to the UE.

In a first example, embodiment, if a flexible uplink subframe was affected by interference caused by a DL data payload transmission from a neighboring base station, then the base station generates a Δ_{A} that accounts for the interference caused by a DL data payload transmission from a neighboring base station during that same flexible subframe. The base station then selects an MCS according to the estimated SINR as modified using Δ_{A}. If the flexible uplink subframe was not affected by interference caused by a DL data payload transmission from a neighboring base station, then the base station generates a Δ_{B} that does not account for the interference caused by a DL data payload transmission from a neighboring base station during that same flexible subframe but preferably does account for DL reference and/or control interference from that base station. The base station then selects an MCS according to the estimated SINR as modified using Δ_{B}.

In a second example, embodiment, if a flexible subframe was affected by interference caused by a DL data payload transmission from a neighboring base station, then the base station generates and selects an MCS according to the estimated SINR as modified using Δ_{common}. If the flexible subframe was not affected by interference caused by a DL data payload transmission from a neighboring base station, then the base station generates both the Δ_{common} and an additional Δ_{additional} that accounts for the interference caused by a DL control signal transmission only from a neighboring base station during that same flexible subframe. The base station then selects an MCS according to the estimated SINR as modified using both the Δ_{common} and an additional Δ_{additional}.

In a non-limiting example LTE-based implementation, a DL data payload transmission may be a PDSCH transmission, a reference signal transmission a CRS transmission, and a control signal transmission may be a PDCCH or PHICH transmission.

### DESCRIPTION OF NON-LIMITING EXAMPLE EMBODIMENTS

The following sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

It should be understood by the skilled in the art that “UE” is a non-limiting term comprising any wireless device or node equipped with a radio interface allowing for at least one of: transmitting signals in UL and receiving and/or measuring signals in DL. A UE herein may comprise a UE (in its general sense) capable of operating or at least performing measurements in one or more frequencies, carrier frequencies, component carriers or frequency bands. It may be a “UE” operating in single- or multi-RAT or multi-standard mode.

A cell is associated with a base station, where a base station comprises in a general sense any node transmitting radio signals in the downlink (DL) and/or receiving radio signals in the uplink (UL). Some example base stations are eNodeB, eNB, Node B, macro/micro/pico radio base station, home eNodeB (also known as femto base station), relay, repeater, sensor, transmitting-only radio nodes or receiving-only radio nodes. A base station may operate or at least perform measurements in one or more frequencies, carrier frequencies or frequency bands and may be capable of carrier aggregation. It may also be a single-radio access technology (RAT), multi-RAT, or multi-standard node, e.g., using the same or different base band modules for different RATs.

The signaling described is either via direct links or logical links (e.g. via higher layer protocols and/or via one or more network nodes). For example, signaling from a coordinating node may pass another network node, e.g., a radio node.

The example embodiments are described in the non-limiting example context of an LTE type system. However, the technology is not limited to LTE, and may apply to any Radio Access Network (RAN), single-RAT or multi-RAT. Some other RAT examples are WCDMA, UMTS, GSM, cdma2000, WiMAX, and WiFi. If applying the technology to WCDMA, for example, those skilled in the art will understand that entities may have different names and functionalities.

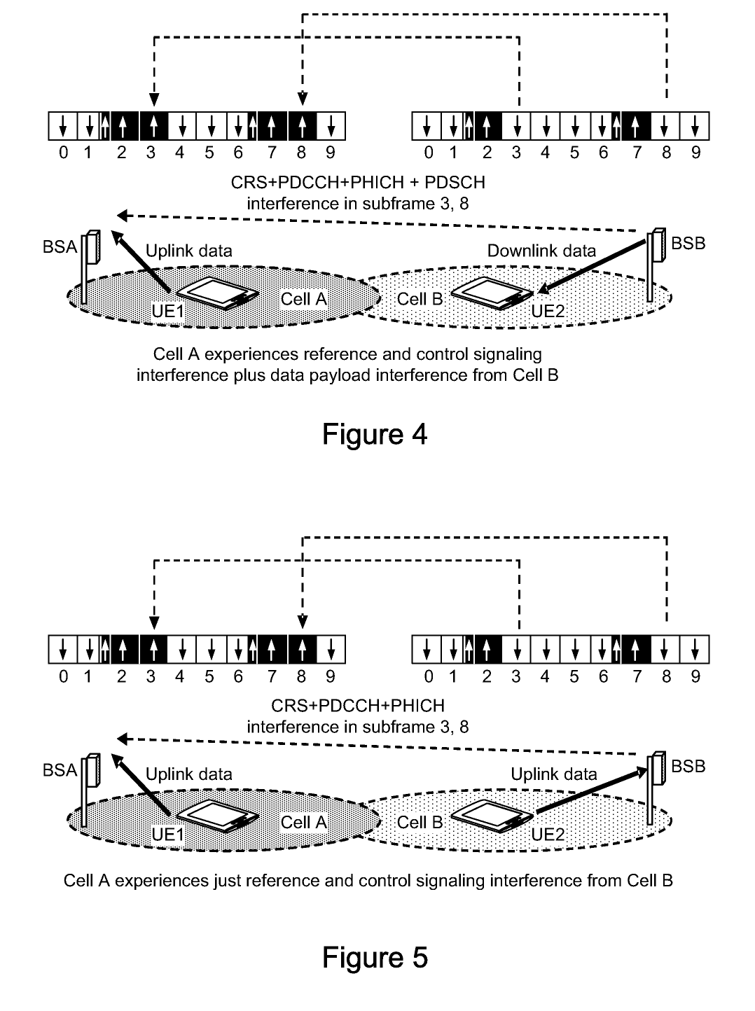

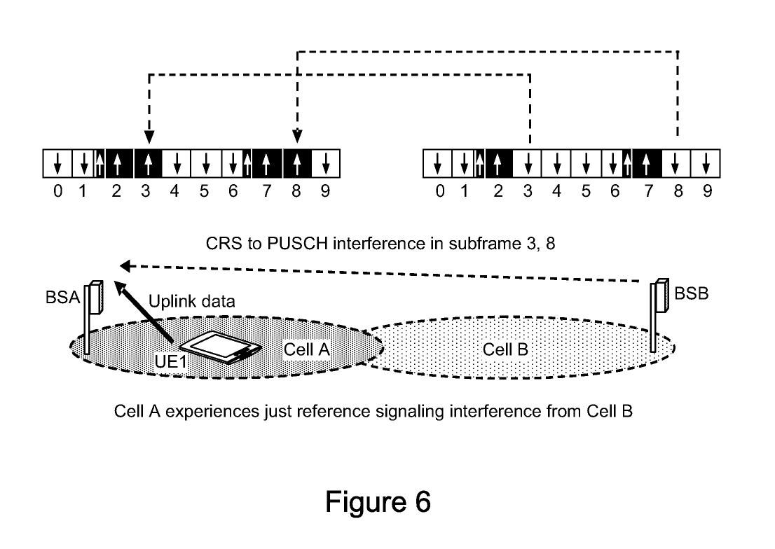

FIGS. 4-6 illustrate interference situations identified in the introduction using cell A served by base station BSA and neighboring cell B served by base station BSB. The ten-subframe configuration for each cell is shown above each cell. In FIG. 4, cell A experiences interference from downlink (DL) reference (e.g., CRS) and control signaling (e.g., PDCCH & PHICH) as well as data payload (e.g., PDSCH) from neighbor cell B in BSB in flexible subframes 3 and 8. In FIG. 5, cell A experiences interference from downlink (DL) reference (e.g., CRS) and control signaling (e.g., PDCCH & PHICH) from neighbor cell B in flexible subframes 3 and 8. In FIG. 6, cell A experiences interference from only the downlink (DL) reference signaling (e.g., CRS) from BSB in neighbor cell B in flexible subframes 3 and 8.

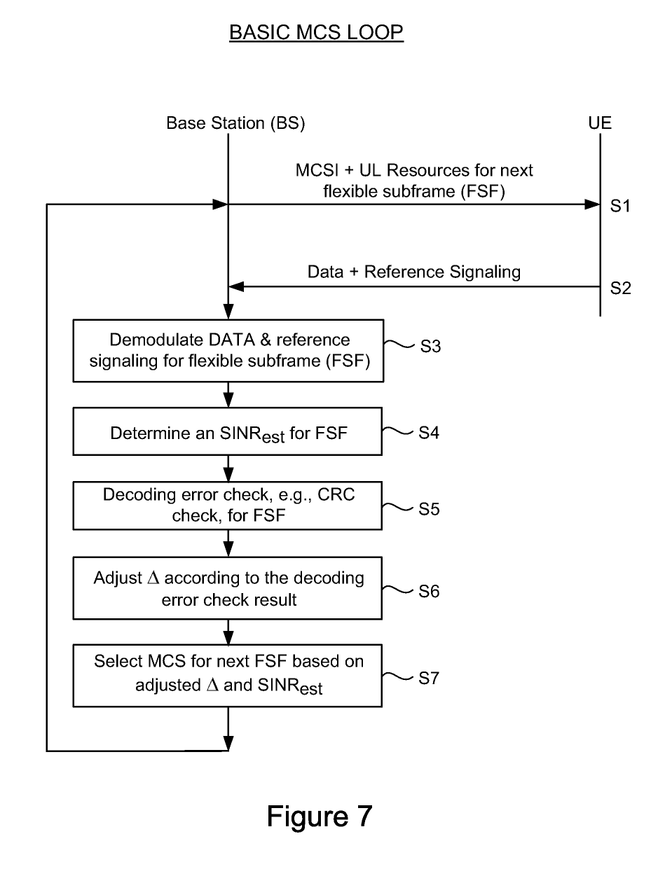

A single-loop link adaptation procedure is illustrated in FIG. 7 using signaling between a base station, e.g., an eNB, and a UE, and functions performed by the base station. In step S1, the base station sends a modulation coding scheme indicator (MCSI) and allocated uplink resources for a next flexible uplink subframe configured for UL transmission of the UE. In response, the UE sends data and reference signaling to the base station on the allocated resources using the indicated modulation and coding scheme (step S2). The base station demodulates the data based on the reference signaling in that flexible uplink subframe (step S3). Based on the demodulation, the base station determines an estimated SINR for the flexible uplink subframe (step S4) and if there is an error, e.g., CRC, check for the flexible uplink subframe (step S5). The base station maps the estimated SINR to an estimated BLER (or BLEP) and determines an error between the target BLER and the estimated BLER. The delta value Δ_{adpated} is then adjusted to reduce the error. One example way to adjust Δ_{adpated} is in accordance with equation 3 repeated here for convenience:

$${Δ}_{adapted} = \{ \begin{matrix}{Δ}_{adapted} - StepSize & ( PUSCH decoding failure ) \\ {Δ}_{adapted} + StepSize \cdot \frac{BLER}{1 - BLER} & ( PUSCH decoding success )\end{matrix} \qquad Equation 3$$

Thus, step S6 reflects the effect of Equation 3 by adjusting Δ_{adpated} according to the decoding error check result in step S5. The base station then adjusts the estimated SINR using the adjusted Δ_{adpated,} selects a MCS for the next transmission in the flexible uplink subframe based on the adjusted SINR (step S7), and returns to step S1 to complete the loop.

A drawback of the link adaptation scheme in FIG. 7 is that it can not differentiate between the two types of DL-to-UL interference from neighboring cell B, i.e., Case (1) where there is only reference and/or control signaling interference, and Case (2) where there is reference and/or control signaling plus data payload interference. In Case (2), the performance of the interfered uplink subframes in cell B suffers. For example, for UL transmit opportunities with only CRS/PHICH/PDCCH interference, the selected modulation and coding scheme (MCS) resulting from link adaptation loop in FIG. 7 can be too high due to an over-estimated SINR, which may lead to poor MCS selection and possibly transmission failure because the actual achieved SINR is lower than the estimated SINR. This results in a low delta value Δ_{adapted} when the link adaptation converges, e.g., a predetermined BLER target is met. When there is switch from Case (1) to Case (2), the delta value Δ_{adapted} is at a low level, even though the SINR over-estimation disappears, a too conservative MCS for the UL transmission opportunities is selected in Case (2). A long time is required to increase the low delta value Δ_{adapted} to a proper level.

Better link adaptation of such flexible subframes configured for uplink transmission that experiences interference from the downlink transmission of one or more neighbor cells is achieved using improved link adaptation technology. A first example embodiment employs a dual-loop link adaptation technology, where each loop basically follows the steps shown in FIG. 7 but with different values for Δ_{adpated}. A first loop is used for UL transmissions in the flexible subframes in cell A when there is no DL data payload, e.g., PDSCH, interference, but there is DL reference and/or control signaling, e.g., CRS/PHICH/PDCCH, interference from one or more neighboring cells. A second loop is used for UL transmissions in the flexible subframes in cell A when there is DL data payload, e.g., PDSCH, as well as reference and some possible control signal interference from the one or more neighboring cells. Thus, different Δ_{adpated} values for the uplink MCS selection in cell A are used according to whether or not DL data payload interference is predicted or determined. A second example embodiment introduces an additional A adjustment to compensate SINR over-estimation when there is only DL reference signal and/or control signaling interference from one or more neighbor cells. The serving cell determines whether to add the additional A adjustment according to whether or not DL data payload interference is predicted or determined.

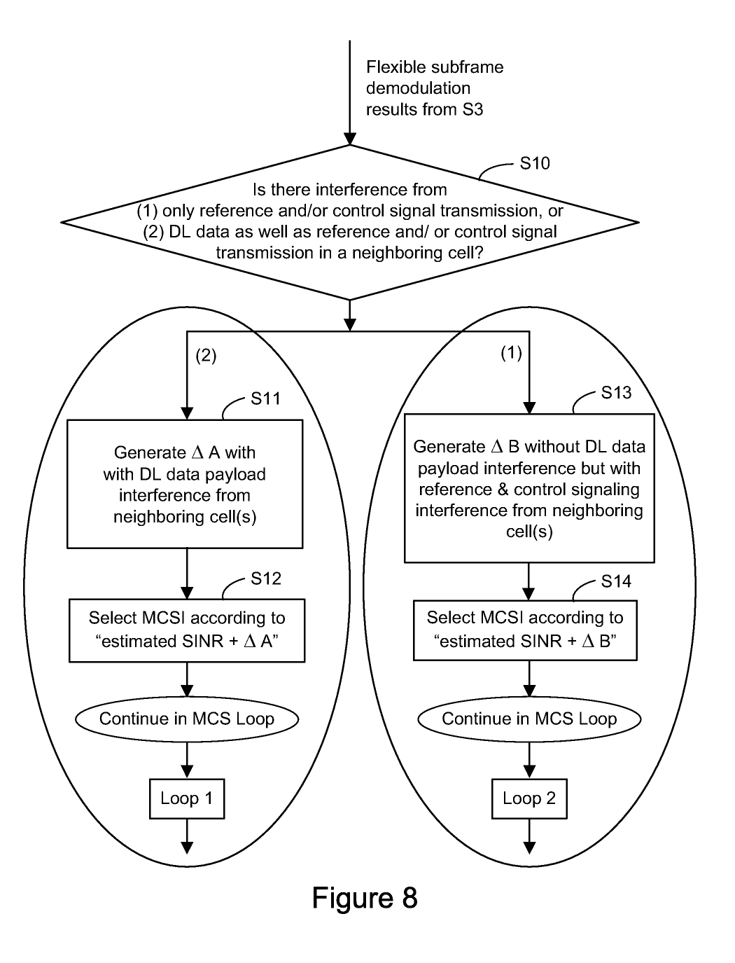

Reference is made to FIG. 8 which is a flowchart that shows example, non-limiting procedures in accordance with the first embodiment. Although the flowchart is directed to a single neighboring base station, it also applies to interference from multiple neighboring base stations. After the UL flexible subframe from the UE is received and demodulated in step S3 in FIG. 7, the base station determines if that flexible subframe was affected by interference caused by a DL data payload transmission as well as reference and possibly control signal transmission from a neighboring base station during that same flexible subframe (step S10). For convenience and consistency with Cases (1) and (2) above, if the interference is Case (2) with interference caused by a DL data payload transmission as well as reference and possibly control signal transmission from a neighboring base station during that same flexible subframe, control proceeds to loop 1 where the base station generates a Δ_{A} that accounts for the interference caused by a DL data payload transmission from a neighboring base station during that same flexible subframe (step S11). The base station then selects an MCS according to the estimated SINR from step S4 as modified using Δ_{A} (step S12) and continues back at step S1 for the next flexible subframe transmission from the UE. If the determination in step S10 is that the flexible subframe was affected by only the reference and control signal transmission from a neighboring base station, i.e., Case (1), control proceeds to loop 2 where the base station generates a Δ_{B} that does not account for the interference caused by a DL data payload transmission from a neighboring base station during that same flexible subframe but only for DL reference and/or control interference from that base station (step S13). The base station then selects an MCS according to the estimated SINR from step S4 as modified using Δ_{B} (step S14) and continues back at step S1 for the next flexible subframe transmission from the UE.

The delta value Δ_{A} can be expected to be higher than Δ_{B} to compensate for the SINR over-estimate. On the other hand, Δ_{A} may be used to accurately manage the MCS selection for Case A, where an SINR over-estimate is less likely because interference experienced in the uplink flexible subframe is not caused by a pure DL reference and/or control signal transmission from a neighboring base station.

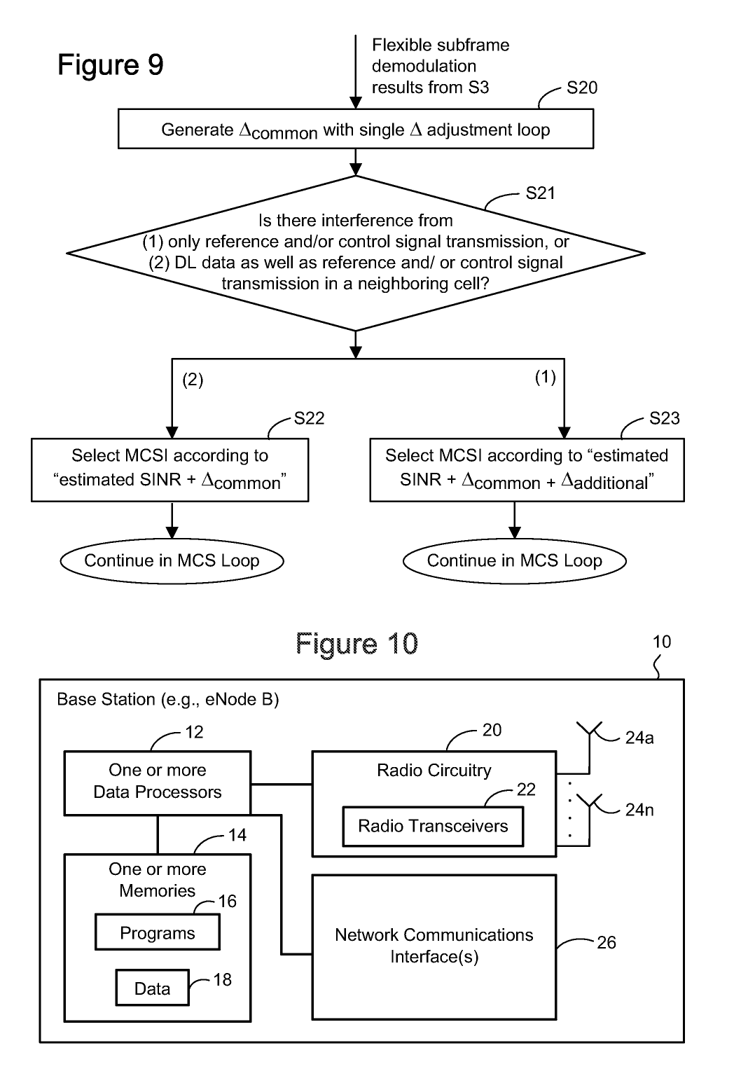

Reference is made to FIG. 9 which is a flowchart that shows example, non-limiting procedures in accordance with the second embodiment. Although the flowchart is directed to a single neighboring base station, it also applies to interference from multiple neighboring base stations. After the UL flexible subframe from the UE is received and demodulated in step S3 in FIG. 7, the base station generates a Δ_{common} that corresponds with the A determined in step S8 of FIG. 7 (step S20). The base station also determines if that flexible subframe was affected by interference caused by a DL data payload, as well as reference and/or control signal transmission, from a neighboring base station during that same flexible subframe (step S21). If so, i.e., Case (2) exists, then the base station selects an MCS according to the estimated SINR from step S4 as modified using Δ_{common} (step S22), which is the same as in step S9 of FIG. 7, and continues back at step S1 for the next flexible subframe transmission from the UE. If the determination in step S21 is that the flexible subframe was affected by only the reference and/or control signal transmission from a neighboring base station, i.e., Case (1), then the base station generates both the Δ_{common} and an additional Δ_{additional} that accounts for the interference caused by only DL reference and or control signal transmission from a neighboring base station during that same flexible subframe. The base station selects an MCS according to the estimated SINR from step S4 as modified using both the Δ_{common} and an additional Δ_{additional} (step S23) and continues back at step S1 for the next flexible subframe transmission from the UE.

The common delta value Δ_{common} may for example be adjusted based on CRC decoding results for a received flexible subframe from the UE in accordance with Equation 4:

$${Δ}_{common} = \{ \begin{matrix}{Δ}_{common} - StepSize & ( PUSCH decoding failure ) \\ {Δ}_{common} + StepSize \cdot \frac{BLER}{1 - BLER} & ( PUSCH decoding success )\end{matrix} \qquad Equation 4$$

The serving cell base station conditionally selects an MCS based on whether the uplink transmission to be scheduled belongs to Case (1) (only interference from the reference and/or control signal transmission from a neighboring base station) or Case (2) (the interference is caused at least in part by a DL data payload as well as reference and/or control signal transmission from a neighboring base station during that same flexible subframe) in accordance with Equation 5.

$${Δ}_{adapted} = \{ \begin{matrix}{Δ}_{common} + {Δ}_{additional} & ( For Case 1 ) \\ {Δ}_{common} & ( For Case 2 )\end{matrix} \qquad Equation 5$$

The additional Δ_{additional} value can be predefined according to a downlink path loss from the interfering neighboring cell (cell B) to the interfered cell (cell A). For example, the interfered cell may look up the Δ_{additional} in a predefined table lookup for a flexible subframe group configured for UL transmission which experiences the interference from the downlink transmission of that neighboring cell.

The example embodiments estimate or determine the type of downlink interference from one or more neighboring cells. For example, PDSCH interference may be detected in a neighboring cell. One example detection approach is to measure a power density of the radio resource elements that may be used for downlink data symbol transmission in the flexible subframes. A PDSCH transmission in the flexible subframe may be detected if the power density exceeds a predetermined threshold. Preferably, the PDSCH transmission in a flexible subframe in a neighboring cell lasts sufficiently long as compared to a total delay of a PDSCH interference measurement and uplink scheduling. As another detection example, the base station can measure the uplink SINR variation for uplink transmissions in the flexible subframes and conclude there is PDSCH transmission occurrence or disappearance in the flexible subframes in a neighboring cell when there is sudden SINR decrease or increase, respectively.

Alternatively, neighboring cell B may signal or otherwise communicate to cell A whether a DL data payload, e.g., PDSCH, and reference and/or control, e.g., CRS, PHICH, PDCCH, transmission will be occurring in one or more flexible subframes. For example, the notification may include a planned PDSCH transmission time period and an index list of the flexible subframes.

FIG. 10 shows a base station, e.g., an eNB, that can be used in example embodiments described above. The base station comprises one or more data processors 12 that control the operation of the base station. The one or more data processors 12 are connected to radio circuitry 20 that includes multiple radio transceivers 22 with associated antenna(s) 24a . . . 24n which are used to transmit signals to, and receive signals from, user equipments (UEs). The base station also comprises one or more memories 14 connected to the one or more data processors 12 and that store program 16 and other information and data 18 required for the operation of the base station and to implement the functions described above. The base station also includes components and/or circuitry 26 for allowing the base station to exchange information with other base stations, e.g., for the data payload transmission notification described above, and/or other network nodes. Hence, the base station serving a UE, for link adaption for uplink subframes comprises the processor 12 being configured to indicate a modulation and coding scheme and uplink transmission resources for transmission by the UE of a succeeding subframe. The radio transceiver 22 or radio circuitry is configured to receive, via antenna 24i, i=a, . . . , n, an uplink transmission from the UE. The processor 12 is further configured to demodulate at least one subframe of said uplink transmission, including performing error detection; and to determine an estimate signal to interference noise ratio (SINR) for said at least one subframe; The processor 12 is further configured to determine whether said at least one subframe was affected by interference cause by a downlink data transmission from a neighboring base station during that same at least one subframe. The processor 12 is further configured to apply an adaptation value to said estimated SINR, and to select a modulation and coding scheme for said succeeding uplink transmission based on at least the adaptation value. The processor 12 is further configured to select a/the modulation and coding scheme for said succeeding uplink transmission based on the estimated SINR. The processor 12 is further configured to modify the estimated SINR using the adaptation value. As previously explained, the subframe is a flexible subframe. Other functions of the base station have been described and need not be repeated again. The adaptation value Δ has already been described in it various forms and definition and in relation to the figures.

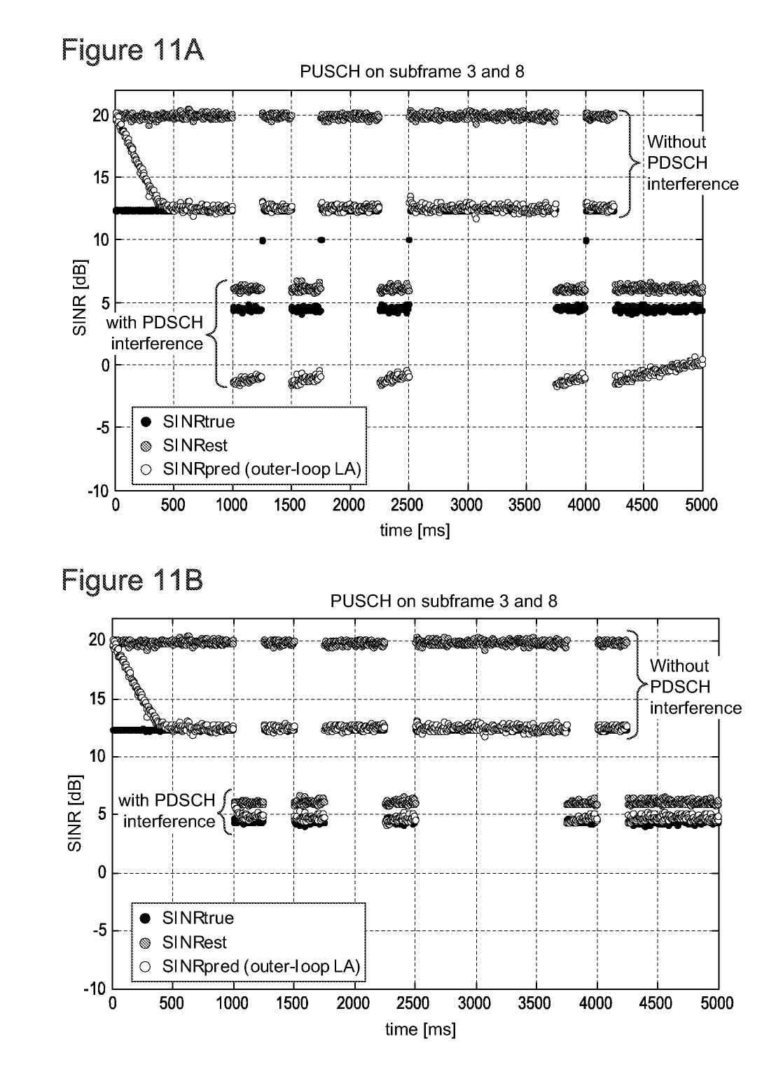

FIG. 11A is a graph of SINR v. time that illustrates example link simulation results to help identify the problem with single loop link adaptation like that in FIG. 7 for the flexible subframes configured for uplink transmission when there is interference from downlink transmission in a neighboring cell. The SINR adjusted using single loop link adaptation like that in FIG. 7 is much lower than the actual SINR in the presence of interference from PDSCH, which is an example of data payload interference. FIG. 11B is a graph of SINR v. time that illustrates example link simulation results for the dual loop link adaptation scheme corresponding to FIG. 8. The adjusted SINR matches the true SINR well especially when compared to FIG. 11A signifying much improved performance of the UL transmission.

The above technology includes multiple advantages. For example, the uplink throughput for the flexible subframes configured for uplink transmission is significantly improved. The actually achieved BLER also better meets the predetermined BLER target and the variation of the delay of the data transmission can be reduced.

Although the description above contains many specifics, they should not be construed as limiting but as merely providing illustrations of some presently preferred embodiments. Embodiments described herein may be considered as independent embodiments or may be considered in any combination with each other to describe non-limiting examples. Although non-limiting, example embodiments of the technology were described in a UTRAN context, the principles of the technology described may also be applied to other radio access technologies. Indeed, the technology fully encompasses other embodiments which may become apparent to those skilled in the art. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved by the described technology for it to be encompassed hereby.

1. A method, in a base station serving a UE, for link adaptation for uplink subframes, comprises:
indicating a modulation and coding scheme and uplink transmission resources for transmission by the UE of a succeeding subframe;
receiving an uplink transmission from the UE;
demodulating at least one subframe of said uplink transmission , including performing error detection;
determining an estimate signal to interference noise ratio, SINR, for said at least one subframe;
determining whether said at least one subframe was affected by interference cause by a downlink data transmission from a neighboring base station during that same at least one subframe;
applying an adaptation value to said estimated SINR, and
selecting a modulation and coding scheme for said succeeding uplink transmission based on at least the adaptation value.

2. The method according to claim 1 wherein selecting further comprising, selection a/the modulation and coding scheme for said succeeding uplink transmission based on estimated SINR.

3. The method according claim 1 further comprises, modifying the estimated SINR using the adaptation value.

4. The method according to claim 1 wherein the subframe is a flexible subframe.

5. A base station serving a UE, for link adaption for uplink subframes, comprises:
a processor configured to indicate a modulation and coding scheme and uplink transmission resources for transmission by the UE of a succeeding subframe;
a radio transceiver configured to receive an uplink transmission from the UE;
the processor further configured to demodulate at least one subframe of said uplink transmission , including performing error detection; and to determine an estimate signal to interference noise ratio, SINR, for said at least one subframe;
said processor is further configured to determine whether said at least one subframe was affected by interference cause by a downlink data transmission from a neighboring base station during that same at least one subframe;
said processor is further configured to apply an adaptation value to said estimated SINR, and to select a modulation and coding scheme for said succeeding uplink transmission based on at least the adaptation value.

6. The base station according to claim 5 wherein said processor is further configured to selection a/the modulation and coding scheme for said succeeding uplink transmission based on the estimated SINR.

7. The base station according claim 5 wherein the processor is further configured to modify the estimated SINR using the adaptation value.

8. The base station according to claim 5 wherein the subframe is a flexible subframe.
